(19) United States
(12) Patent Application Publication
(10) Pub. No.: US 2007/0187949 A1
(43) Pub. Date: Aug. 16, 2007

(54) Sheet-backed label assembly

(75) Inventors: Michinori Uruno, Tokyo (JP); Naomi Akazawa, Tokyo (JP)

Correspondence Address: SUGHRUE-265550, 2100 PENNSYLVANIA AVE. NW, WASHINGTON, DC, 20037-3213, US

(73) Assignee: PIONEER CORPORATION, Meguro-ku (JP)

(21) Appl. No.: 11/655,921

(22) Filed: Jan. 22, 2007

(30) Foreign Application Priority Data
Jan. 20, 2006 (JP) P2006-012071

(51) Int. Cl. B42D 15/00

(52) U.S. Cl. 283/105

(57) ABSTRACT

According to an aspect of the embodiment, a sheet-backed label assembly includes a backing sheet. The backing sheet comprise plural labels capable of being peeled off the backing sheet, a first easy breaking line along which to break the backing sheet to separate the plural labels from each other, and a second easy breaking line which is formed at such a position as to intersect the first easy breaking line and to traverse the labels.

### CROSS-REFERENCE TO RELATED APPLICATIONS

This application is based on and claims the benefit of priority from the prior Japanese Patent Application No. 2006-012071, filed on Jan. 20, 2006; the entire contents of which are incorporated herein by reference.

### BACKGROUND

1. Technical Field

The present invention relates to a sheet-backed label assembly which is formed in such a manner that a backing sheet and each label stuck to the backing sheet can be separated from each other.

2. Description of Related Art

A sheet-backed label assembly is used which incorporate various kinds of labels having an adhesive layer such as delivery slips. When a label is to be used actually, a backing sheet that is stuck to the label so as to cover it is peeled of the label.

One exemplary sheet-backed label is a sheet body in which a top sheet is stuck to a backing sheet. And a label portion and a form portion are arranged adjacent to each other in the sheet body.

The label portion is bonded to the backing sheet in such a manner that it can be peeled off the backing sheet because of the presence of a release agent layer on the front surface of the backing sheet and an adhesive layer on the back surface of the top sheet. The form portion is divided into a slip-bearing piece and an information-bearing piece by a folding line (or perforation line). The slit-bearing piece is completely bonded to the backing sheet by the adhesive layer on the back surface of the top sheet, and the information-bearing piece is bonded to the backing sheet in such a manner that it can be peeled off the backing sheet because of the presence of the release agent layer on the front surface of the backing sheet and the adhesive layer on the back surface of the top sheet. This structure provides a label form in which a delivery slip and a delivery document are integrated with each other and which is superior in printability (refer to JP-A-2005-125599, for example).

A sheet-backed label assembly in which labels that are stuck to a backing sheet can be removed easily has also been proposed.

In this sheet-backed label assembly, closed perforation lines are formed in a backing sheet so as to correspond to respective labels and the labels having paste on their back surfaces are stuck to the backing sheet at positions corresponding to the positions of the perforation lines, respectively.

Each label is stuck to the backing sheet in such a manner that most of the label boundary is located outside the closed perforation line and an element of the backing sheet enclosed by the perforation line partially sticks out from part of the label boundary.

A label and an element of the backing sheet enclosed by the perforation line are removed together from the backing sheet, and are together stuck to a target object. When the sticking of the label has become no longer necessary, the label and the backing sheet element are peeled off by pinching the latter (refer to JP-A-7-271306, for example).

FIG. 1 is a perspective view a conventional sheet-backed label assembly.

The sheet-backed label assembly 1 shown in FIG. 1 is a delivery slip used for a courier service or the like, and is composed of a top sheet 2 (usually, a stack of plural sheets including transfer sheets) having an adhesive layer on the back side and bearing information on the front side and two backing sheets 3 and 4 which are stuck to the top sheet 2 so as to cover respective adhesive regions 6 and 7 of its adhesive layer. A non-adhesive region 5 is provided between the adhesive regions 6 and 7, and extended portions 3a and 4a of the respective backing sheets 3 and 4 are provided so as to cover the non-adhesive region 5.

In the sheet-backed label assembly 1, longer sidelines 8a and 8b are formed as a result of cutting along perforation lines. That is, the top sheet 2 and the backing sheet (the combination of the backing sheets 3 and 4) are approximately the same in size. Plural sets of a top sheet 2 and a backing sheet are connected to each other at the longer sidelines 8a and 8b in such a manner that they can be separated from each other into plural sheet-backed label assemblies 1.

### SUMMARY

However, in the related-art sheet-backed label assembly 1 shown in FIG. 1, the backing sheet and the label (top sheet 2) are approximately the same in size. Therefore, for the backing sheets 3 and 4 to be peeled off easily, it is necessary to form the non-adhesive region 5 and to provide the extended portions 3a and 4a (pinching portions).

That is, a relatively complicated structure needs to be employed in which to facilitate peeling of the backing sheets 3 and 4 the non-adhesive region 5 which divides the adhesive layer and the extended regions 3a and 4a which correspond to the non-adhesive region 5 are provided.

Label sticking work is performed in the following manner. The backing sheet 4 is peeled off by pinching the extended portion 4a, and the adhesive region 7 is stuck to a prescribed location. Then, the backing sheet 3 is peeled off by pinching the other extended portion 3a located under the top sheet 2 and the adhesive region 6 is stuck to complete the sticking work.

In the above work of sticking the top sheet 2 (label), the manipulation of peeling off the backing sheet 3 and sticking the adhesive region 6 by pinching the other extended portion 3a located under the top sheet 2 may not be high in work efficiency because the extended portion 3a may be difficult to pinch depending on its size.

In the sheet-backed label assembly described in Patent document 2, three of the perforation lines formed along the sidelines of a rectangle are covered with a label, which results in a drawback that cutting along the perforation lines is difficult to perform.

Examples of problems to be solved by the invention are that in separating a label from a sheet-backed label assembly a separating manipulation along separation lines such as perforation lines is difficult to perform, and that the operability of a label sticking manipulation is low.

### BRIEF DESCRIPTION OF DRAWINGS

FIG. 1 is a back-side perspective view showing the structure of a related-art sheet-backed label assembly (courier service slip);

FIGS. 2A and 2B are exemplary plan views of the sheet-backed label assembly according to example 1 of embodiments, in which FIG. 2A shows a front surface of the assembly and FIG. 2B shows a bottom surface thereof;

FIG. 3 is an exemplary plan view of Example 2 of the sheet-backed label assembly.

FIG. 4 is a plan view of Example 3 of the sheet-backed label assembly.

FIG. 5 is a plan view of Example 4 of the sheet-backed label assembly.

FIG. 6 is a plan view of Example 5 of the sheet-backed label assembly.

FIG. 7 is a plan view of Example 6 of the sheet-backed label assembly.

FIG. 8 is a plan view of Example 7 of the sheet-backed label assembly.

FIG. 9 is a plan view of Example 8 of the sheet-backed label assembly.

FIG. 10 is a plan view of Example 9 of the sheet-backed label assembly.

FIG. 11 is a perspective view illustrating a manipulation of detaching one piece of the sheet-backed label assembly.

FIG. 12 is a perspective view illustrating a manipulating of sticking one label of the sheet-backed label assembly.

FIG. 13 is a plan view showing an exemplary sheet-backed label assembly in which plural columns of labels are arranged in the horizontal direction.

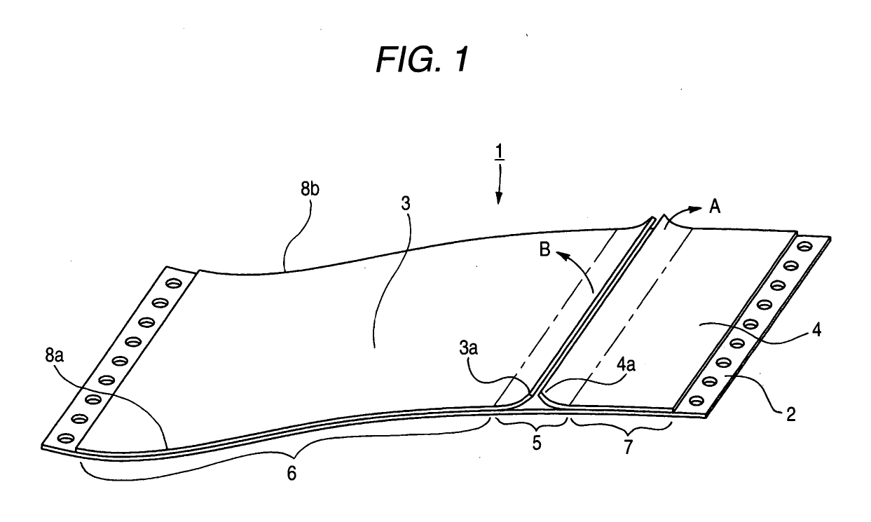

### DESCRIPTION OF THE EMBODIMENTS

Embodiments of the present invention will be hereinafter described.

According to an embodiment, a sheet-backed label assembly is configured in such a manner that a backing sheet and each label stuck to the backing sheet can be separated from each other. The best mode for carrying out the invention is such that plural labels are provided on the backing sheet, that first easy breaking lines to be used for separating the labels from each other are provided between the labels, and that a second easy breaking line is formed at such a position as to intersect the first easy breaking lines and to traverse the labels.

With this structure, since the first easy breaking lines such as perforation lines are provided between the labels, the breaking lines can be seen and hence the ease of a breaking manipulation is enhanced. Furthermore, since the second easy breaking line is located at such a position as to traverse the labels and is connected to the first easy breaking lines, a backing sheet element can be separated at the second easy breaking line and the adhesive layer of one end portion of the associated label can be exposed by continuing the same manipulation as a manipulation of breaking the backing sheet along a first easy breaking line. The ease of a sticking manipulation can thus be enhanced very much.

The sheet-backed label assembly according to the embodiment may be such that gaps are provided between the labels and the first easy breaking lines are located in the gaps. With this structure, when the backing sheet is cut along a first easy breaking line, a resulting backing sheet element is wider than the label and a label sticking manipulation can be performed by pinching a portion of the backing sheet element that sticks out from the label. This manipulation can be performed without causing an event that a finger or the like touches the adhesive layer of the label.

The sheet-backed label assembly according to the embodiment may be such that the first easy breaking lines extend from the second easy breaking line to one end line of the backing sheet.

With this structure, a cutting manipulation along a first easy breaking line is completed when the cutting point reaches the second breaking line and the same manipulation (the same hand movement) that follows can peel off a backing sheet element and a label. When the backing sheet is cut along a first easy breaking line, breaking of the backing sheet from its one end to the second easy breaking line and partial peeling of a label can be effected simultaneously.

The sheet-backed label assembly according to the embodiment may be such that the first easy breaking lines extend from one end line of the backing sheet to the other end line thereof past the second easy breaking line.

With this structure, when the backing sheet is cut along a first easy breaking line, the cutting can not only be performed reliably from the one end of the backing sheet to the other end but also be performed starting from either of the right end and the left end.

The sheet-backed label assembly according to the embodiment may be such that the first easy breaking lines extend from one end line of the backing sheet to the other end line thereof, and that force for peeling a label off the backing sheet is set weaker than force for breaking, after breaking the backing sheet along a first easy breaking line to the second easy breaking line, the backing sheet along a remaining part of the first easy breaking line.

With this structure, a cutting manipulation along a first easy breaking line is completed at the second easy breaking line without causing an event that cutting is performed all the way along the first easy breaking line. A backing sheet element and a label can be peeled off by continuing the same movement as the completed cutting manipulation along the first easy breaking line.

The sheet-backed label assembly according to the embodiment may be such that the first easy breaking lines are perforation lines and the second easy breaking line is a cut slit.

The term “perforation line” as used herein means a cutting line in which perforations completely penetrating through the backing sheet in its thickness direction and portions each connecting the adjacent perforations are formed continuously at a prescribed pitch and along which the backing sheet can easily be cut with hands without the need for using any tool. Basically, the term “cut slit” as used herein means a slit that completely penetrates through the backing sheet in its thickness direction and extends continuously over a clearly greater length than the above-mentioned perforation. Alternatively, the cut slit may be a half-cut slit that turns to a full cut that completely penetrates through the backing sheet in its thickness direction when an operator bends the sheet-backed label assembly a little there while holding it with his or her hands.

With this structure, one can start to peel a label off the backing sheet merely by continuing the same hand movement after cutting the backing sheet along a first easy breaking line (perforation line) without the need for cutting the backing sheet along a cut slit.

The sheet-backed label assembly according to the embodiment may be such that the first easy breaking lines and the second easy breaking line are cut slits, and that the backing sheet is continuous at portions that are adjacent to ends of the respective first easy breaking lines.

With this structure, a label can be taken and part of its adhesive layer can be exposed very easily merely by cutting the backing sheet connecting portion that is adjacent to a first easy breaking line.

The sheet-backed label assembly according to the embodiment may be such that the first easy breaking lines are cuts that are located on an end line of the backing sheet.

This structure makes it possible to easily recognize the locations visually where to cut the backing sheet.

The sheet-backed label assembly according to the embodiment may be such that each of the first easy breaking lines is formed by a cut located on an end line of the backing sheet and a perforation line that is continuous with the cut.

This structure makes it possible to easily recognize the locations visually where to cut the backing sheet as well as to cut the backing sheet easily, that is, to take a label easily.

The sheet-backed label assembly according to the embodiment may be such that each of the first easy breaking lines is formed by a cut slit and a perforation line that is continuous with the cut slit and extends to an end line of the backing sheet.

With this structure, since each first easy breaking line is a combination of a cut slit and a perforation line, the degree of ease of cutting of a first easy breaking line can be set properly taking the thickness, strength, etc. of the backing sheet into consideration.

The sheet-backed label assembly according to the embodiment may be such that two columns each including plural labels are arranged in a right-left direction and the first easy breaking lines and the second easy breaking lines are arranged symmetrically in the right-left direction.

This structure makes it possible to provide a sheet-backed label assembly having more labels.

The sheet-backed label assembly according to the embodiment may be such that in a state that the backing sheet has been broken along a first easy breaking line and an adhesive-exposed portion is formed in a label, the adhesive-exposed portion is smaller than the other portion of the label that is covered with a backing sheet element.

That is, the second easy breaking line is disposed so as to traverse the labels at a position that is deviated from centers of the labels. With this structure, until a label is stuck to a prescribed location after taking it, since the area of the adhesive-exposed portion is small, unexpected sticking during a manipulation can be prevented. Furthermore, the label rigidity is substantially maintained even in the adhesive-exposed portion, which facilitates positioning during a tentative bonding manipulation.

The sheet-backed label assembly according to the embodiment may be such that the second easy breaking line is disposed so as to traverse the labels approximately at centers of the labels.

With this structure, the first easy breaking lines can be formed so as to be connected to either of the right and left end lines of the backing sheet or both of them. In the latter case, the backing sheet can be cut from either of the right side and the left side, which enhances the ease of use.

The sheet-backed label assembly according to the embodiment may be such that marks corresponding to the respective labels are provided on a continuous portion of the backing sheet that remains after elements of the backing sheet have been removed by breaking the backing sheet along first easy breaking lines.

This structure makes it possible to count the number of used labels easily after peeling those labels off the backing sheet by counting corresponding marks.

In a method for counting the number of used labels of the sheet-backed label assembly according to the embodiment, the number of peeled labels is counted by using a continuous portion of the backing sheet that remains after the labels have been peeled off. Since a continuous portion of the backing sheet remains, the amount of small fractions of dust can be reduced.

This method makes it possible to count the number of used labels reliably and very easily.

A label sticking method for the sheet-backed label assembly according to the embodiment comprises the steps of breaking the backing sheet along a first easy breaking line; peeling a label and a backing sheet element off the backing sheet at the second easy breaking line; bringing an adhesive-exposed portion of the label into contact with a target location; and sticking the label to the target location while peeling the label off the backing sheet element by holding a portion of the backing sheet element that sticks out from a sideline of the label.

With this label sticking method, in sticking a label, a series of sticking manipulations from positioning of the label to its final sticking can be performed continuously while a portion, sticking out from the label, of a backing sheet element which is wider than the label is held with a hand.

The sheet-backed label assembly according to the embodiment may be such that a label main body of each of the labels is made of light-transmissive (transparent or semitransparent) resin film, and that a viewable print layer or the like is provided in an adhesive layer which is provided on a back surface of the label main body or between the label main body and the adhesive layer.

The adhesive layer and the print layer are formed so that when a label once stuck to a target object is peeled off, part of the print layer is peeled off the label main body together with an associated part of the adhesive layer (the part of the adhesive layer is kept stuck to the target object).

In this structure, when a label once stuck to a target object is peeled off, the adhesive layer of the label tends to peel off the label main body. And the label main body is made of transparent or semitransparent resin film. Therefore, when a label is re-stuck to a target object, there should be a trace of the print layer having been peeled off. One can visually recognize such a partially peeled print layer.

### EXAMPLE 1

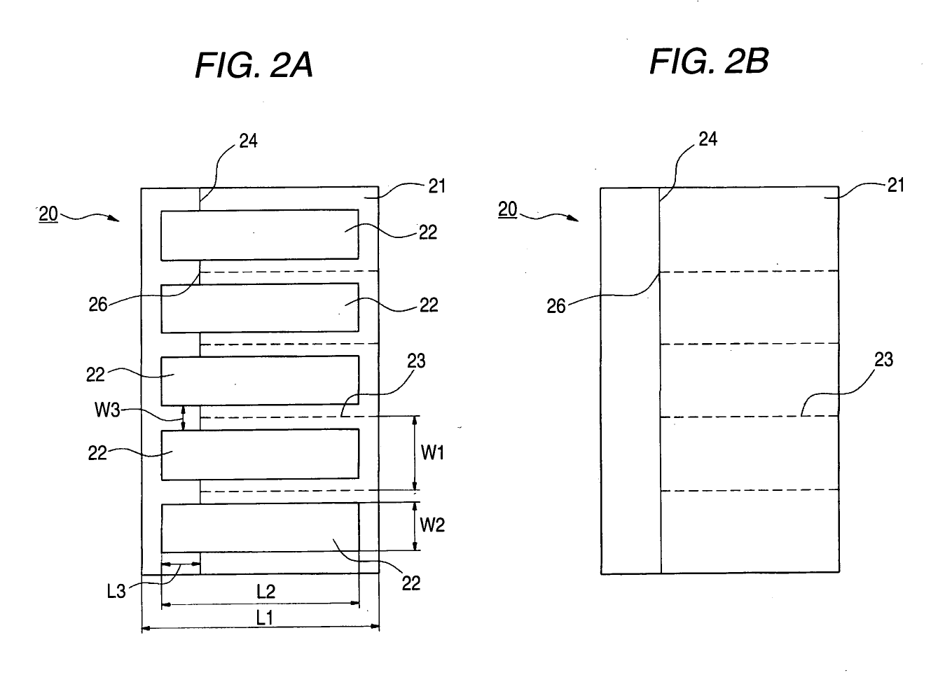

The sheet-backed label assembly of Example 1 shown in FIG. 2 will be described.

The sheet-backer label assembly 20 of this Example is configured in such a manner that a backing sheet 21 and each of plural labels 22 which are stuck to the backing sheet 21 can be separated from each other. More specifically, the back surfaces of the labels 22 are provided with an adhesive layer and the backing sheet 21 is provided with a release agent layer to make it easier to peel off the labels 22.

The materials of the labels 22 and the backing sheet 21 are not limited to particular ones. However, in general, they can be made of woodfree paper, film, or the like.

The backing sheet 21 is provided with, between the plural labels 22, perforation lines 23 as first easy breaking lines to be used for separating the labels 22 from each other. The backing sheet 21 is also provided with a cut slit 24 as a second easy breaking line which extends perpendicularly to the perforation lines 23 (first easy breaking lines) and intersects the perforation lines 23 at intersecting points 26 so as to form T shapes there. The cut slit 24 is formed at such a position as to traverse the labels 22. As shown in FIG. 2(b) showing the back surface, the cut slit 24 is formed continuously even in those portions of the backing sheet 21 which are located under the labels 22. Also in the other Examples 2 to 9, a cut slit(s) is formed continuously in the portions of a backing sheet 21 which are located under the labels 22.

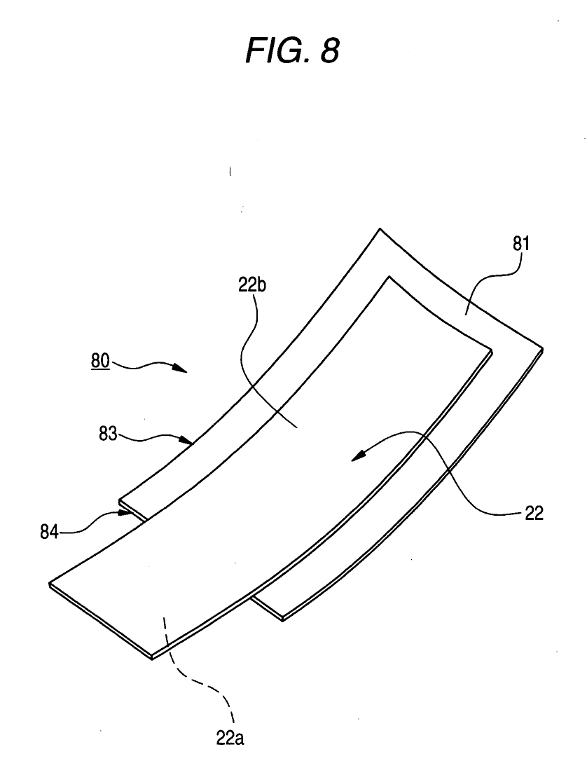

With the above structure, since the perforation lines 23 are exposed between the labels 22, the breaking lines can be seen and hence a breaking manipulation can be performed easily. The fact that the cut slit 24 (second easy breaking line) is located at such a position as to traverse the labels 22 and is connected to the perforation lines 23 (first easy breaking lines) allows the following manipulation. When a perforation breaking manipulation, that is, a perforation shearing manipulation for removing a label 22, is performed by making a rolling-up hand movement from the right side, breaking occurs along the perforation line 23 from the right side. After the breaking reaches the cut slit 24, the label 22 starts to be separated from the backing sheet 21 at the cut slit 24. The single label 22 can be separated so as to have an adhesive-exposed portion 22a (see FIG. 8) where part of the adhesive layer of the label 22 is exposed.

Subsequently, the exposed adhesive layer is stuck to a prescribed location to fix the one end portion of the label 22 tentatively. Then, the label 22 can be stuck to the prescribed location completely while peeling the label 22 off the element of the backing sheet 21 (which is wider than the label 22) by pinching a portion, sticking out from the label 22, of the backing sheet element.

This sticking manipulation from removal of the label 22 to its sticking is a series of continuous manipulations which are free of any extra actions such as changing the hands (pairs of fingers) to pinch the label 22. The ease of a sticking manipulation can thus be enhanced very much.

In the sheet-backed label assembly 20 of Example 1, the labels 22 are provided on the backing sheet 21 at intervals W3 and each perforation line 23 is formed at such a position as to divide the interval into two approximately equal lengths. By virtue of this structure, when the backing sheet 21 is cut along a perforation line 23, a cutaway element of the backing sheet 21 is always larger than the label 22 and each portion, sticking out from the label 22, of the cutaway element of the backing sheet 21 is given a sufficiently large size in a stable manner.

No particular limitations are imposed on the dimensions of the backing sheet 21 and the labels 22. For example, the width L1 of the backing sheet 21 and the interval W1 between the perforation lines 23 may be set at about 80 mm and 15 mm, respectively. And the label length L2 and the label width W2 may be set at about 70 mm and 10 mm, respectively. The length L3 of the portion of each label 22 to become an adhesive-exposed portion may set at about 20 mm.

In the sheet-backed label assembly 20 of this Example, the perforation lines 23 extend from the cut slit 24 to the one end line (right end line in FIG. 2). It can be said that this structure assures that a perforation cutting manipulation is completed when the cutting point reaches the cut slit 24 and the same manipulation (the same hand movement) that follows can peel off an element of the backing sheet 21 and a label 22.

The label main body may be made of light-transmissive (transparent or semitransparent) resin film, and a viewable print layer or the like may be provided in the adhesive layer which is provided on the back surface of the label main body or between the label main body and the adhesive layer. The adhesive layer and the print layer are formed so that when a label 22 once stuck to a target object is peeled off, part of the print layer is peeled off the label main body together with an associated part of the adhesive layer (i.e., the part of the adhesive layer is kept stuck to the target object).

When a label 22 once stuck to a target object is peeled off, the adhesive layer of the label 22 tends to peel off the label main body. And the label main body is made of transparent or semitransparent resin film. Therefore, when a label 22 is re-stuck to a target object, there should be a trace of the print layer that was peeled off. One can see such a partially peeled print layer and hence can recognize the re-sticking of the label 22.

This structure makes it possible to find re-sticking of a label 22 and to give the labels 22 a pilfer-proof function.

### EXAMPLE 2

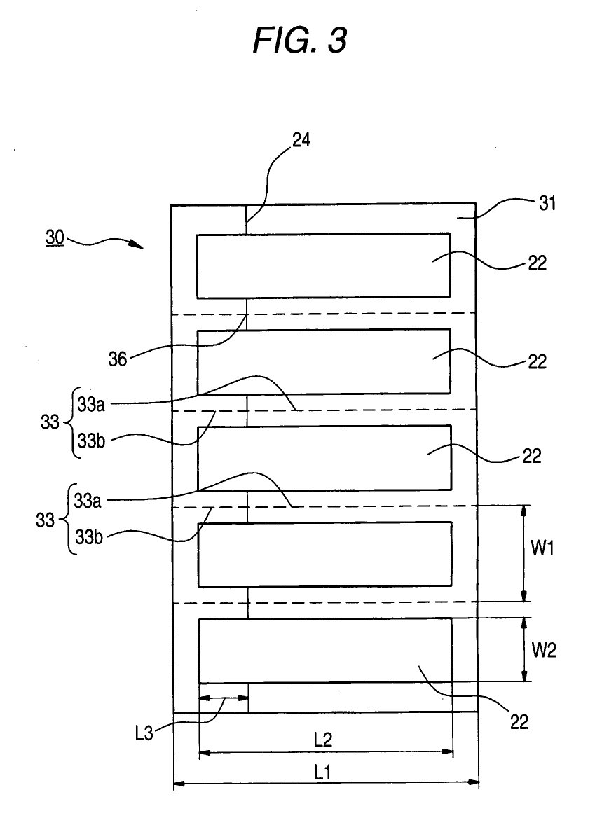

Example 2 according to the invention will be described below in detail with reference to FIG. 3.

In a sheet-backed label assembly 30 of Example 2, perforation lines 33 as first easy breaking lines extend from one end line of a backing sheet 31 to the other end line past a cut slit 24 as a second easy breaking line. That is, cruciform shapes are formed around intersecting points 36.

With the above structure, the backing sheet 31 can not only be cut reliably along a perforation line 33 from one end of the backing sheet 31 to the cut slit 24 but also be cut from either side, that is, along a right-hand perforation line 33a or a left-hand perforation line 33b.

In the sheet-backed label assembly 30 of Example 2, the perforation lines 33 extend from one end line of the backing sheet 31 to the other end line and the force necessary for peeling a label 22 off the backing sheet 31 is set weaker than the force necessary for breaking, after breaking the backing sheet 31 along a perforation line 33 to the cut line 24, the backing sheet 31 along the remaining part of the perforation line 33.

That is, a perforation cutting manipulation is completed at the cut slit 24 without cutting the backing sheet 31 all the way along a perforation line 33. A label 22 can be peeled off the backing sheet 31 by continuing the same action as a perforation cutting action.

### EXAMPLE 3

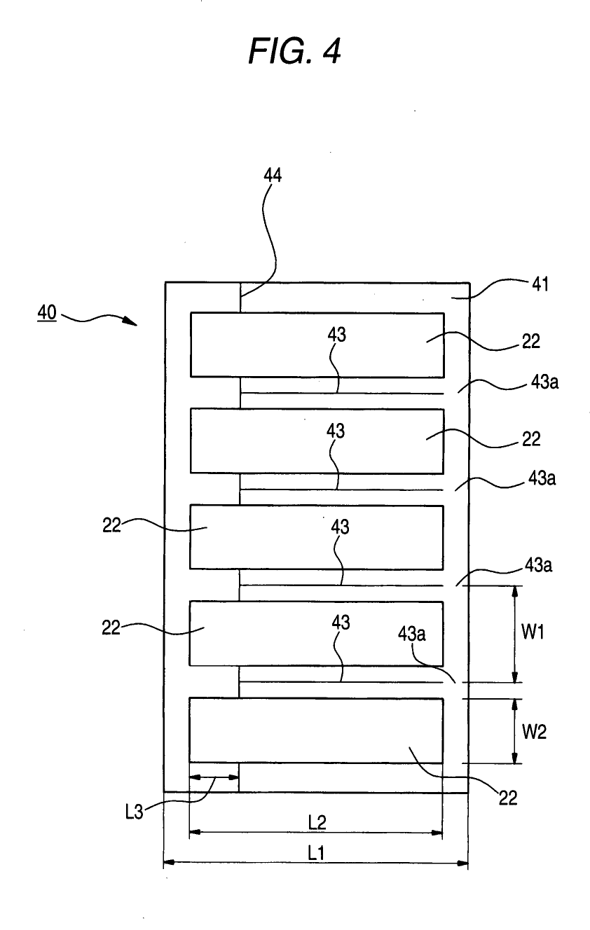

Example 3 according to the invention will be described below in detail with reference to FIG. 4.

A sheet-backed label assembly 40 of Example 3 is configured in such a manner that first easy breaking lines 43 and a second easy breaking line 44 are cut slits, and that a backing sheet 41 is continuous at end portions 43a which are adjacent to one ends (the right ends in FIG. 4) of the respective first easy breaking lines 43.

With the above structure, removing a label 22 and exposing part of the adhesive layer of the label 22 can be done very easily, that is, merely by cutting the end portions 43a of first easy braking lines which make the backing sheet 41 continuous.

That is, since the cut slits completely penetrate through the backing sheet 41 in its thickness direction, a label 22 can be peeled off the backing sheet 41 very easily without requiring any force for cutting the backing sheet 41 along the cut slits.

### EXAMPLE 4

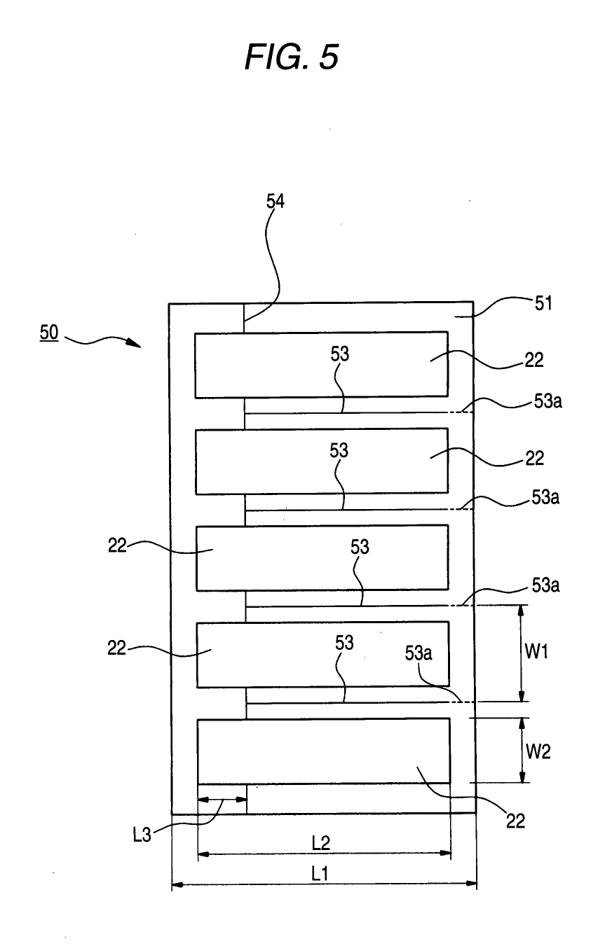

Example 4 according to the invention will be described below in detail with reference to FIG. 5.

A sheet-backed label assembly 50 of Example 4 is configured in such a manner that a major part of each first easy breaking line 53 and a second easy breaking line 54 are cut slits, and that a backing sheet 51 is continuous at end portions 53a (right end portions in FIG. 5) of the respective first easy breaking lines 53, the end portions 53a being perforation lines.

With the above structure, a label 22 can be taken very easily, that is, merely by cutting the backing sheet 51 along the end portion 53a of a first easy breaking line 53 that makes the backing sheet 51 continuous there.

In the sheet-backed label assembly 50 of this Example, since each first easy breaking line 53 is a combination of a cut slit and a perforation line, the degree of ease of cutting of a first easy breaking line 53 can be set properly taking the thickness, strength, etc. of the backing sheet 51 into consideration.

### EXAMPLE 5

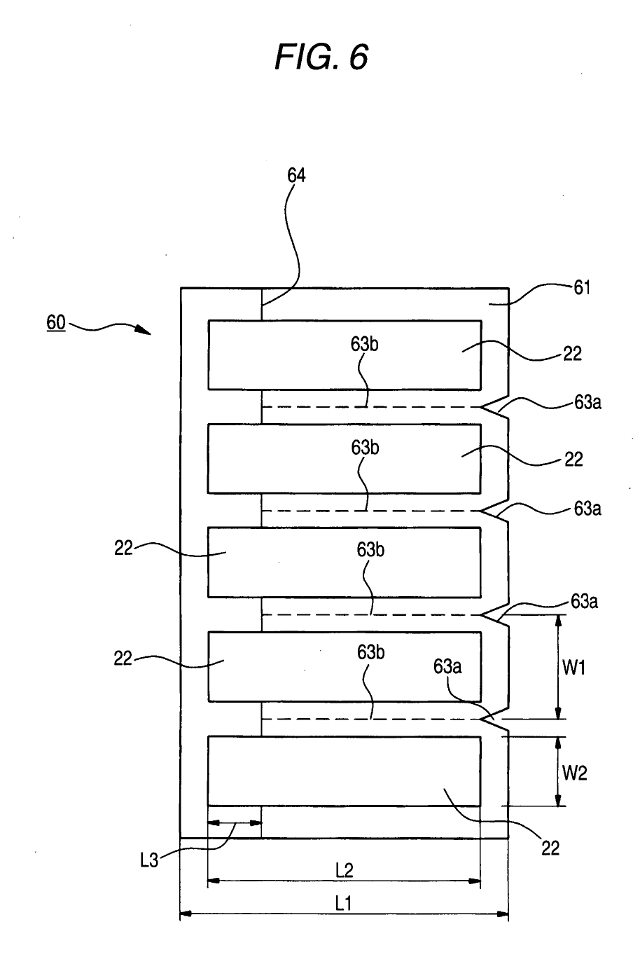

Example 5 according to the invention will be described below in detail with reference to FIG. 6.

In a sheet-backed label assembly 60 of this Example, each easy breaking line is formed by a cut 63a which is located on one end line of a backing sheet 61 and a perforation line 63b which is connected to the cut 63a.

With the above structure, the positions where to start cutting the backing sheet 61 are seen easily and a label 22 can be taken easily by cutting the backing sheet 61 easily.

Alternatively, the sheet-backed label assembly 60 of this Example may be such that each first easy breaking line is formed only by the cut 63a which is formed on one end line of the backing sheet 61.

### EXAMPLE 6

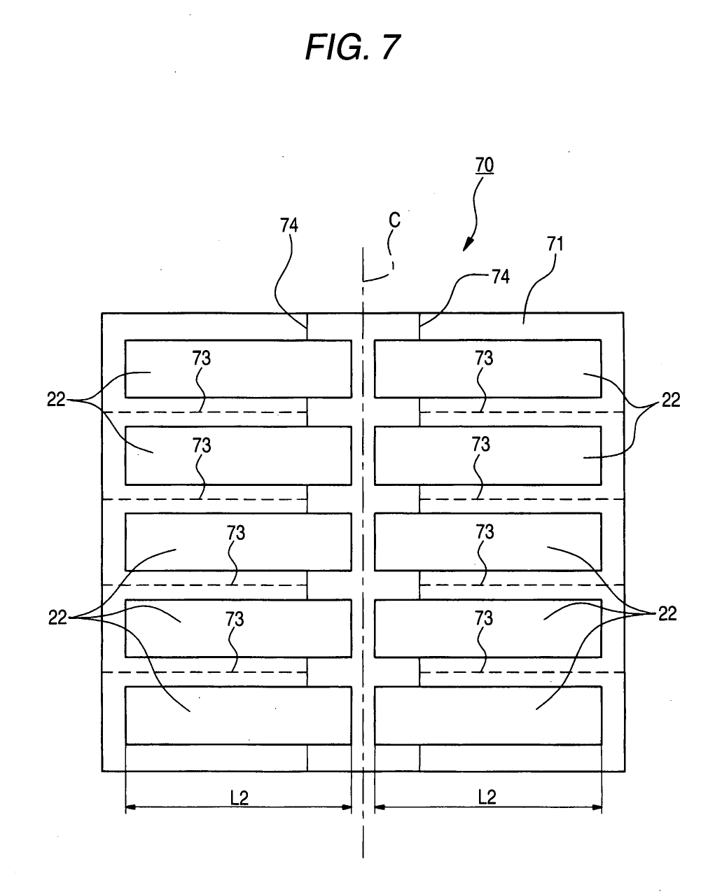

Example 6 according to the invention will be described below in detail with reference to FIG. 7.

A sheet-backed label assembly 70 of this Example is configured in such a manner that two columns each including plural labels 22 are arranged in the right-left direction, and that first easy breaking lines 73 and second easy breaking lines 74 are arranged symmetrically in the right-left direction with respect to a center line C. That is, Example 6 is configured in such a manner that two sheet-backed label assemblies 20 each shown in FIG. 2 are connected to each other so as to be symmetrical in the right-left direction.

This structure makes it possible to provide a sheet-backed label assembly 70 having more labels 22.

### EXAMPLE 7

Example 7 according to the invention will be described below in detail with reference to FIG. 8.

A sheet-backed label assembly 80 of this Example is configured so that an adhesive-exposed portion 22a of a label 22 that has been separated through breaking along a first easy breaking line 83 is smaller than a non-adhesive-exposed portion 22b of the label 22 which is covered with an element of a backing sheet 81.

That is, a second easy breaking line 84 traverses the label 22 at a position that is deviated from the center of the label 22. With this structure, until a label 22 is stuck to a prescribed location after taking it, since the area of the adhesive-exposed portion 22a is small, the adhesive-exposed portion 22a is prevented from, for example, hanging down, which in turn prevents its unexpected sticking during a manipulation. The label rigidity is substantially maintained even in the adhesive-exposed portion 22a, which facilitates positioning during a tentative bonding manipulation.

In this Example, the second easy breaking line 84 is formed at the position that is deviated from the center of the label 22 to the right or left. For example, a structure in which the second easy breaking line 84 is located to the right of the center (which is contrary to the case of FIG. 2) is suitable for a left-handed operator.

### EXAMPLE 8

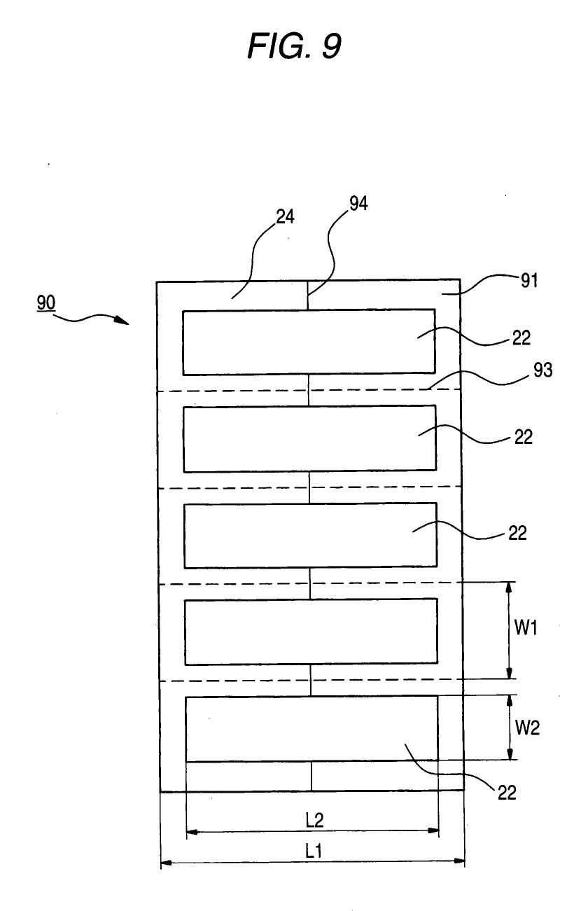

Example 8 according to the invention will be described below in detail with reference to FIG. 9.

A sheet-backed label assembly 90 of this Example is configured in such a manner that a second easy breaking line 94 traverses labels 22 approximately at their centers. First easy breaking lines 93 extend all the way between the right and left end lines of a backing sheet 91.

With this structure, the backing sheet 91 can be cut from either of the right side and the left side. The ease of use is thus enhanced.

### EXAMPLE 9

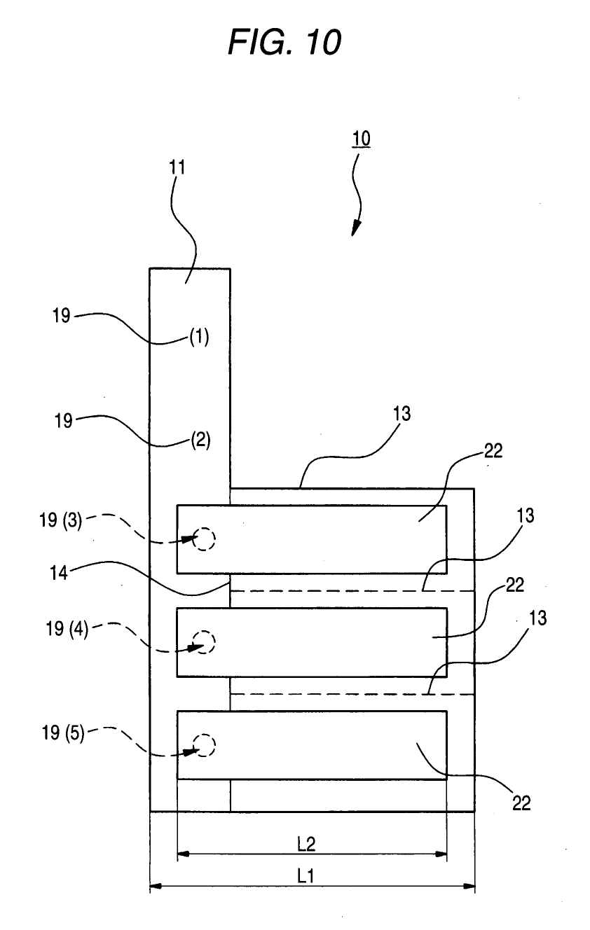

Example 9 according to the invention will be described below in detail with reference to FIG. 10.

A sheet-backed label assembly 10 of Example 9 is configured in such a manner that marks 19 which are consecutive numbers (in FIG. 10, (1), (2), (3), (4), and (5)) corresponding to respective labels 10 are provided on that continuous portion of a backing sheet 11 which will remain after the backing sheet 11 is broken along first easy breaking lines 13.

With the above structure having the marks 19, after labels 22 are peeled off the backing sheet 11, one can easily recognize the number of used labels 22 by looking at the marks 19 (or by counting marks 19 if the marks 19 are not numbers).

As for the method for counting used labels 22 of the sheet-backed label assembly 10 of this Example, in an exemplary use form in which a residual portion (that remains after removing labels 22) of a long backing sheet 11 is taken up in roll form, the marks 19 may be formed so as to easily be detected mechanically (e.g., they are formed as holes) to enable their mechanical (automatic) detection. This method makes it possible to count used labels 22 reliably and very easily.

In the case of single-label backing sheets 11, plural backing sheets 11 may be given serial numbers. This makes it possible to easily recognize the number of used backing sheets 11 at the end of work in, for example, a case of sticking a large number of labels.

The feature of providing the marks 19 according to this Example may be applied to the other Examples in which the first easy breaking lines and the second easy breaking line(s) are formed in different manners.

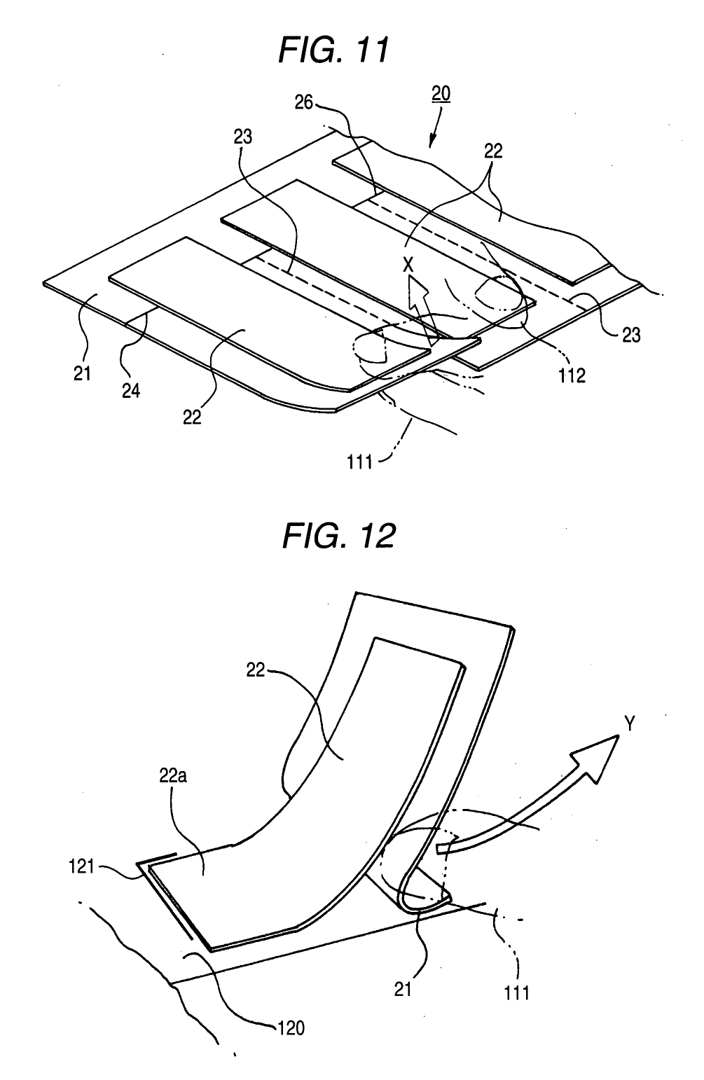

A label removing manipulation and a label sticking manipulation to be performed on the sheet-backed label assembly according to the embodiment of the invention will be described below with reference to FIGS. 11 and 12.

As shown in FIG. 11, a manipulation of applying shearing force to a perforation line 23 is performed by pinching the lowest label 22 and the corresponding element of the backing sheet 21 with fingers 111 of the right hand and raising the right hand (in the direction indicated by arrow X in FIG. 11) while pressing a right end portion of the combination of the second lowest label 22 and the corresponding element of the backing sheet 21 with a finger 112 of the left hand. The backing sheet 21 is broken along the perforation line 23 from the right side by the above hand movement as shown in FIG. 11. When the breaking point reaches the cut slit 24, the label 22 starts to be separated from the backing sheet 21 and the single label 22 is removed in a state that part of its adhesive layer is exposed.

Then, as shown in FIG. 12, the removed label 22 is fixed tentatively by sticking the adhesive-exposed portion 22a to a target object 120 at a prescribed position (e.g., at a position indicated by a positioning mark 121). Subsequently, the label 22 is stuck completely by performing a manipulation of peeling the label 22 off the element of the backing sheet 21 (moving the fingers in the direction indicated by arrow Y in FIG. 12) while pinching a portion, sticking out from a sideline of the label 22, of the element of the backing sheet 21.

In this sticking manipulation, no extra actions such as changing the hands (pairs of fingers) to pinch the label 22 need not be performed from the removal of the label 22 to its sticking. As such, this sticking manipulation is a series of continuous manipulations starting from the label removal, and hence can be made much easier.

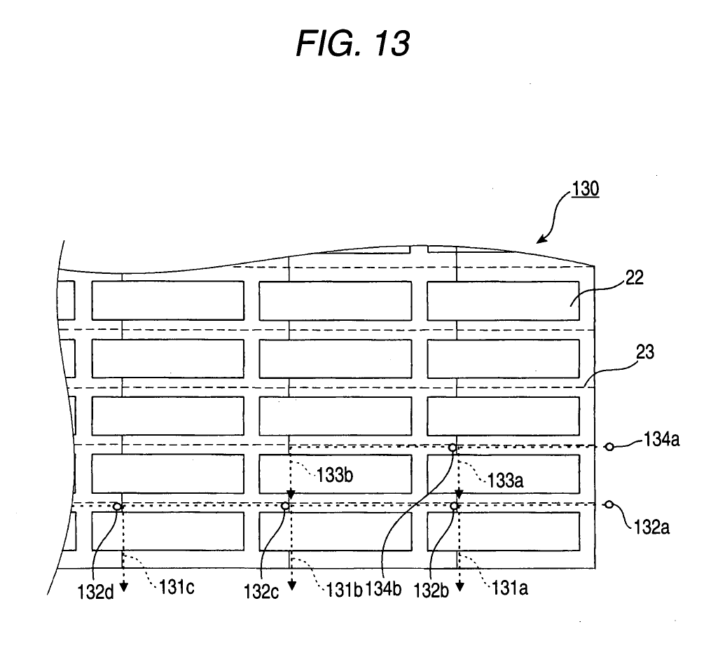

The sheet-backed label assembly according to the embodiment of the invention may be configured in such a manner that plural columns of labels are arranged in the horizontal direction. That is, plural sheet-backed label assemblies each illustrated in each of the above Examples may be connected to each other continuously in the horizontal direction. FIG. 13 shows an exemplary sheet-backed label assembly according to the embodiment of the invention in which plural columns of labels are arranged in the horizontal direction.

A description will be made below of an exemplary label removing manipulation which is performed on the sheet-backed label assembly 130 of FIG. 13 in which the plural columns of labels are arranged.

In FIG. 13, reference symbols 131a, 131b, 131c, 131d, 133a, 133b, . . . denote arrows indicating label removal directions and symbols 132a, 132b, 132c, . . . , 134a, 134b, . . . denote removing manipulation start positions for the respective labels.

First, the lowermost, right-end label 22 and the corresponding backing sheet element are pinched with fingers or the like and shearing force is applied to the perforation line 23, whereby the backing sheet is broken starting from the position 132a and the label 22 and the backing sheet element are removed in the direction indicated by the arrow 131a. Then, the backing sheet is broken starting from the position 132b and the second rightmost label 22 and the corresponding backing sheet element are removed in the direction indicated by the arrow 131b. In the same manner, the combinations of a label 22 and a backing sheet element are removed in right-to-left order in the directions indicated by the arrows 131c, 131d, . . . .

After the lowermost labels 22 and the corresponding backing sheet elements have been removed, the second lowermost labels 22 and the corresponding backing sheet elements are removed in right-to-left order in the directions indicated by the arrows 133a, 133b, . . . .

In the above-described manner, a label removing manipulation can be performed continuously and smoothly even on the sheet-backed label assembly 130 in which the plural columns of labels are arranged in the horizontal direction.

A label removing manipulation may be performed starting from the left end. For a left-handed operator, performing a label removing manipulation starting from the left end increases the work efficiency.

As described above in detail, in the sheet-backed label assembly according to the embodiment of the invention, the first easy breaking lines for separation of the labels 22 from each other are provided between the labels 22 and the second easy breaking line is provided at such a position as to intersect the first easy breaking lines and to traverse the labels 22. Therefore, separation of a label 22 from the backing sheet and its sticking can be performed continuously and smoothly.

In the sheet-backed label assembly according to the embodiment of the invention, the first easy breaking lines are provided between the labels 22. Therefore, the breaking lines can be seen, which enhances the ease of a breaking manipulation. Furthermore, since the second easy breaking line is formed at such a position as to traverse the labels 22 and is connected to the first easy breaking lines, a backing sheet element can be separated at the second easy breaking line and the adhesive layer of one end portion of a label 22 can be exposed by continuing the same manipulation as a manipulation of breaking the backing sheet along a first easy breaking line. The ease of a sticking manipulation can thus be enhanced very much.

As for the method for counting the number of used labels 22 of the sheet-backed label assembly according to the embodiment of the invention, the number of used labels 22 can be counted by using a continuous, residual portion of the backing sheet that remains after the labels have been peeled off. This method makes it possible to count the number of used labels 22 reliably and very easily.

According to the label sticking method of the sheet-backed label assembly according to the embodiment of the invention, a label can be stuck to a target location by breaking the backing sheet along a first easy breaking line, peeling the label 22 and the backing sheet element off the backing sheet 21 at the second easy breaking line, bringing an adhesive-exposed portion of the label 22 into contact with the target location, and finally sticking the label 22 to the target location while peeling the label 22 off the backing sheet element by holding a portion, sticking out from a sideline of the label 22, of the backing sheet element. That is, in sticking a label 22, a series of sticking manipulations from positioning of the label 22 to its final sticking can be performed continuously while a portion, sticking out from the label 22, of a backing sheet element which is wider than the label 22 is held with a hand.

Although the sheet-backed label assembly according to the invention is of a sheet-like form, it may be a long one or may be wound in roll form. Each label may be a printed label or a plain, printable label like a printing sheet for a personal computer. Furthermore, the shape of each label is not limited to a rectangle as employed in the Examples and may be other various shapes.

What is claimed is:

1. A sheet-backed label assembly comprising:
a backing sheet comprising;
plural labels capable of being peeled off the backing sheet;
a first easy breaking line along which to break the backing sheet to separate the plural labels from each other; and
a second easy breaking line which is formed at such a position as to intersect the first easy breaking line and to traverse the plural labels.

2. The sheet-backed label assembly according to claim 1, wherein a gap is provided between the plural labels, and
wherein the first easy breaking line is located in the gap.

3. The sheet-backed label assembly according to claim 1, wherein the first easy breaking line extends from the second easy breaking line to one end line of the backing sheet.

4. The sheet-backed label assembly according to claim 1, wherein the first easy breaking line extends from one end line of the backing sheet to the other end line of the backing sheet.

5. The sheet-backed label assembly according to claim 4, wherein force for peeling the plural labels off the backing sheet is weaker than force for breaking, after breaking the backing sheet along the first easy breaking line to the second easy breaking line, the backing sheet along a remaining part of the first easy breaking line.

6. The sheet-backed label assembly according to claim 1, wherein the first easy breaking line is a perforation line, and
wherein the second easy breaking line is a cut slit.

7. The sheet-backed label assembly according to claim 1, wherein the first easy breaking line and the second easy breaking line are cut slits, and
wherein the backing sheet is continuous in portions that are adjacent to end of the first easy breaking line.

8. The sheet-backed label assembly according to claim 1, wherein the first easy breaking line is cut that is located on an end line of the backing sheet.

9. The sheet-backed label assembly according to claim 1, wherein the first easy breaking line is formed by a cut and a perforation line,
wherein the cut is located on an end line of the backing sheet, and
wherein the perforation line is continuous with the cut.

10. The sheet-backed label assembly according to claim 1, wherein the first easy breaking line is formed by a cut slit and
wherein a perforation line is continuous with the cut slit, and
wherein the perforation line extends to an end line of the backing sheet.

11. The sheet-backed label assembly according to claim 1, wherein two columns each including the plural labels are arranged in a right-left direction, and
wherein the first easy breaking line and the second easy breaking line are arranged symmetrically in the right-left direction.

12. The sheet-backed label assembly according to claim 1, wherein the second easy breaking line is disposed so as to traverse the plural labels at a position that is deviated from center of the plural labels.

13. The sheet-backed label assembly according to claim 1, wherein the second easy breaking line is disposed so as to traverse the plural labels approximately at center of the plural labels.

14. The sheet-backed label assembly according to claim 1, wherein marks corresponding to the respective plural labels are provided on a continuous portion of the backing sheet that remains after the backing sheet have been removed by breaking the backing sheet along first easy breaking lines.

15. The sheet-backed label assembly according to claim 1, wherein each label comprises a label main body of light-transmissive resin film, the label main body having an adhesive layer that is provided on a back surface thereof,
wherein a viewable printed layer is provided between the label main body and the adhesive layer, and
wherein the adhesive layer and the print layer are formed so that when the plural labels once stuck to a target object is peeled off, a part of the print layer is peeled off the label main body together with an associated part of the adhesive layer.

16. A method for counting a number of labels comprising;
counting a number of peeled plural labels by using a continuous portion of the backing sheet that remains after the plural labels of the sheet-backed label assembly according to claim 1 is peeled off.

17. A label sticking method for a sheet-backed label assembly, comprising:
breaking the backing sheet of the sheet-backed label according to claim 1 along the first easy breaking line;
peeling the plural labels and a backing sheet element off the backing sheet at the second easy breaking line;
bringing an adhesive-exposed portion of the plural labels into contact with a target location; and
sticking the plural labels to the target location while peeling the plural label off the backing sheet element by holding a portion of the backing sheet element that sticks out from a sideline of the plural labels.
